(19) United States
(12) Patent Application Publication
(10) Pub. No.: US 2011/0264392 A1
(43) Pub. Date: Oct. 27, 2011

(54) METHOD FOR CORRECTING THE DRIFT OF A PRESSURE SENSOR SIGNAL

(75) Inventors: Alain Ramond, Merville (FR); Mariano Sans, Blagnac (FR); Simon-Didier Venzal, Toulouse (FR)

(73) Assignee: CONTINENTAL AUTOMOTIVE FRANCE, Toulouse (FR)

(21) Appl. No.: 13/129,736

(22) PCT Filed: Nov. 2, 2009
(86) PCT No.: PCT/EP09/07825

§ 371 Date: Jul. 15, 2011

(30) Foreign Application Priority Data
Nov. 19, 2008 (FR) 0806463

(51) Int. Cl. G06F 19/00

(52) U.S. Cl. 702/98

(57) ABSTRACT

A method for correcting the drift of the signal from a sensor measuring the pressure in a cylinder of an internal combustion engine, the signal being comparable to a straight line of equation y=A×x+B, on which signal are overlaid pressure spikes, the correction method includes:
I: using a rapid Kalman filter for detecting the points belonging to the pressure spikes,
II: using a slow Kalman filter for determining of the slope (A) and of the constant (B),
III: correcting, for each point, of the drift of the signal according to whether or not they belong to the detected pressure spikes determined during step I and the values of the slope and constant determined during the step II,
   wherin, during step I:
   the prediction error (eps_{R}) on a point of the signal is estimated using the rapid Kalman filter,
   the standard deviation of this prediction error (eps sigma) is filtered and maximized,
   the start and/or end of a pressure spike at this point is determined according to at least one of the following two criteria:
      the prediction error (eps_{R}) on this point is above a spike start threshold (delta1_up),
      the filtered and maximized standard deviation of the prediction error (eps sigma) on this point is above a spike start standard deviation threshold (eps_sigma_S1).

The present invention relates to a method for correcting the drift of the signal from a pressure sensor. It is particularly useful for the pressure sensors that measure the pressure in a cylinder of an internal combustion engine.

The pressure prevailing in the combustion chamber of a diesel engine cylinder is measured by a pressure sensor located, for example, in a glouplug. The curve giving the pressure as a function of time during a cycle of the engine (intake, compression, combustion, exhaust) exhibits a basic signal that is ideally rectilinear and centered on zero, on which pressure spikes are periodically overlaid. This type of sensor is usually provided with a piezoelectric sensitive element.

Given the operating environment of this sensor, it is exposed to temperature and pressure variations. In particular, the temperature variations create pyroelectricity in the piezoelectric sensitive element of the sensor, which modifies the value of the pressure signal that it delivers. The appearance of the curve giving the pressure as a function of time at the output of the sensor is therefore different from the curve of the real pressure prevailing in the cylinder. More specifically:
the basic signal is no longer centered on zero, that is to say, the measured average pressure value is offset by a constant B,
the basic signal is no longer parallel to the x axis, that is to say, horizontal, but exhibits a slope A and is of type y=A×x,
the slope A and the constant B are not fixed in time and can therefore vary from one engine cycle to another.

Thus, the basic signal can be likened to a straight line, the equation of which is of the type y=A×x+B, on which signal pressure spikes are periodically overlaid. This basic signal therefore has to be processed in order to provide the engine computer with real and reliable pressure measurements, correctly recentered on zero (or on a predefined constant value) and without temporal drift.

A processing algorithm for this signal must correct the signal supplied by the sensor, that is to say that it must therefore make it possible to:
determine B,
determine A,
discriminate the peaks relative to the drifts of the basic signal, by determining the location and the duration of the pressure spikes. In practice, if the sudden increase in pressure due to the spikes is not processed independently of the drift of the signal, it distorts the determination of the slope A and of the constant B,
subtract, from the signal supplied by the sensor, the determined basic signal (A×x+B), to recenter it on zero (or on a predefined constant value).

The signal can be processed either during the acquisition of the signal and directly by the sensor, or after the acquisition of the signal by an external microprocessor. The latter solution presents the advantage of performing the processing once the signal is acquired, with computation means and the necessary time available in an engine control computer. This does, however, present the disadvantage of permanently overloading the memory size of the computer.

The direct processing by the pressure sensor presents numerous constraints: it must be rapid, accurate and limited in memory size used, since it is incorporated in the sensor which does not have a powerful built-in computer provided with a large memory. It is known from the prior art that the direct processing of the signal can be done by estimation, according to the least squares method, of a linear model over a sliding window of points containing N points.

The major drawback in such a processing is the large memory size that is then needed for the calculations. Simplifications and approximations can be made to reduce it, which then causes calculation accuracy and stability problems.

Other methods for processing the signal can be envisaged, such as the use of a Kalman filter for example. This filter relies on a recursive method for error correction between a signal and its prediction attenuated by a gain. The prediction of the signal is calculated on the basis of the signal filtered and corrected at the preceding measurement instant. However, applying such a method to a pressure signal that includes spikes at regular intervals presents the following drawbacks:
if the correction is too great, then the determination of the slope A and of the constant B is distorted since it is overestimated by the presence of the pressure spikes,
if the correction is low, the corrected signal does not take account of the error engendered by the presence of the pressure spikes and is then close to the straight line y=A×x+B. Consequently, the values of the slope A and of the constant B are correct, but the pressure spikes are disregarded.

The present invention proposes to determine the values of the slope A and of the constant B as well as the pressure spikes in a reliable manner without requiring a significant calculation memory size.

These aims of the invention are achieved by means of a method for correcting the drift of the signal (Sb) from a pressure sensor measuring the pressure in a cylindee of an internal combustion engine, the signal being comparable to a succession of points forming a basic signal (Sa) represented by a straight line of equation y=A×x+B, of slope A and of constant B, on which signal are overlaid pressure spikes, said correction method comprising the following steps:
I: the use of a rapid Kalman filter, that is to say, comprising gains of slope (Ka_{R}) and of constant (Kb_{R}) with values close to 1, for the detection of the points belonging to the pressure spikes,
II: the use of a slow Kalman filter, that is to say, comprising gains of slope (Kaᵢ) and of constant (Kb_{'}) with values close to 0, for the determination of the slope (A) and of the constant (B) of the straight line representing the basic signal,
III: the correction, for each point, of the drift of the signal according to whether or not they belong to the detected pressure spikes determined during the step I and of the values of the slope (A) and of the constant (B) determined during the step II in order to determine the real signal (Sr) of the pressure prevailing in the cylinder.
   Said method is noteworthy in that, during the step I:
the prediction error (eps_{R}) on a point of the signal is estimated using the rapid Kalman filter used,
the standard deviation of this prediction error (eps_sigma) is filtered and maximized to estimate the stability of this point relative to the preceding points,
the start and/or the end of a pressure spike at this point is determined according to at least one of the following two criteria:
   the prediction error (eps_{R}) on this point is above a spike start threshold (delta1_up),
   the filtered and maximized standard deviation of the prediction error (eps_sigma) on this point is above a spike start standard deviation threshold (eps_sigma_S1).

Preferentially, the spike start standard deviation threshold is equivalent to the last minimum value of the filtered and maximized standard deviation, multiplied by a spike start coefficient.

In a complementary manner, the end of the spike is determined at a point according to at least one of the following two criteria:
the prediction error on this point is below a spike end threshold,
the filtered and maximized standard deviation of the error on this point is below a spike end standard deviation threshold.

Advantageously, the spike end standard deviation threshold is equivalent to the last maximum value of the filtered and maximized standard deviation, multiplied by a spike end coefficient.

In another embodiment, during the step II:
the slope and the constant of the straight line are estimated from the slow Kalman filter,
the points belonging to the pressure spike determined by the rapid Kalman filter during the step I are replaced by the points predicted by the slow Kalman filter by using the previously estimated slope and constant.

In a supplementary embodiment, during the step III, the straight line, determined during the step II, is subtracted from the signal obtained from the sensor.

According to the invention, the slope gain of the rapid Kalman filter is greater than the slope gain of the slow Kalman filter and the constant gain of the rapid Kalman filter is greater than the constant gain of the slow Kalman filter.

Judiciously, the slope gain of the rapid Kalman filter is less than the constant gain of the rapid Kalman filter and the slope gain of the slow Kalman filter is less than the constant gain of the slow Kalman filter.

The invention also relates to any device for correcting a signal, the signal possibly being a pressure signal, implementing the method exhibiting any one of the preceding characteristics.

Thus, the invention applies to any pressure signal sensor comprising the device for correcting a pressure signal according to the invention.

And the invention also relates to any electronic computer comprising the device for correcting a pressure signal according to the invention.

Other features and advantages of the invention will become apparent from reading the following description, given as a nonlimiting example, and from examining the appended drawings in which:

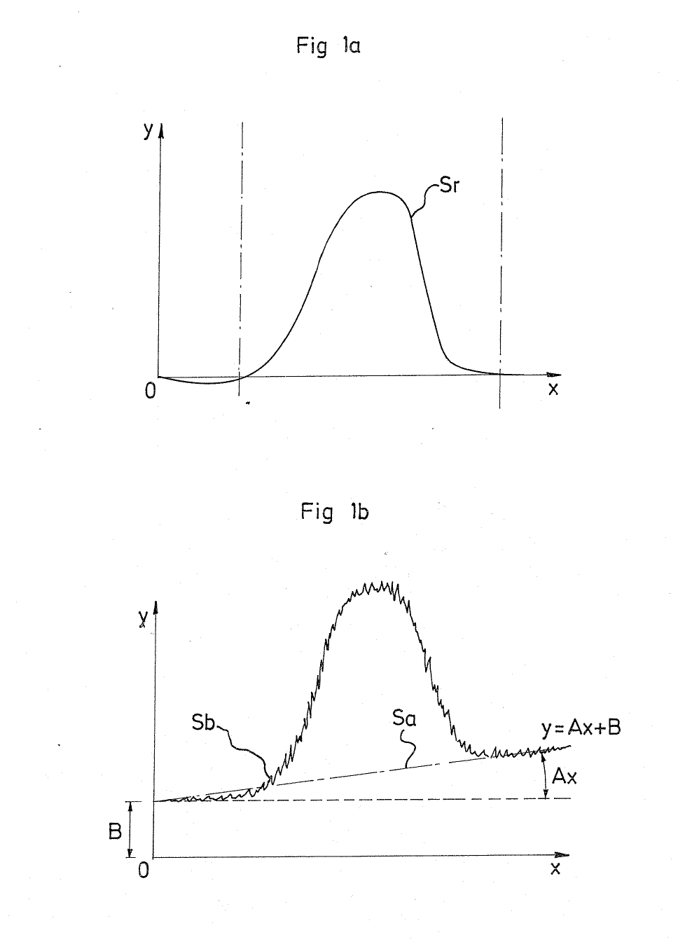

FIG. 1a is a schematic representation of a curve of real pressure in a cylinder of an internal combustion engine over time, during a compression,

FIG. 1b is a schematic representation of a curve of pressure in a cylinder of an internal combustion engine over time, during a compression, as delivered by the pressure sensor,

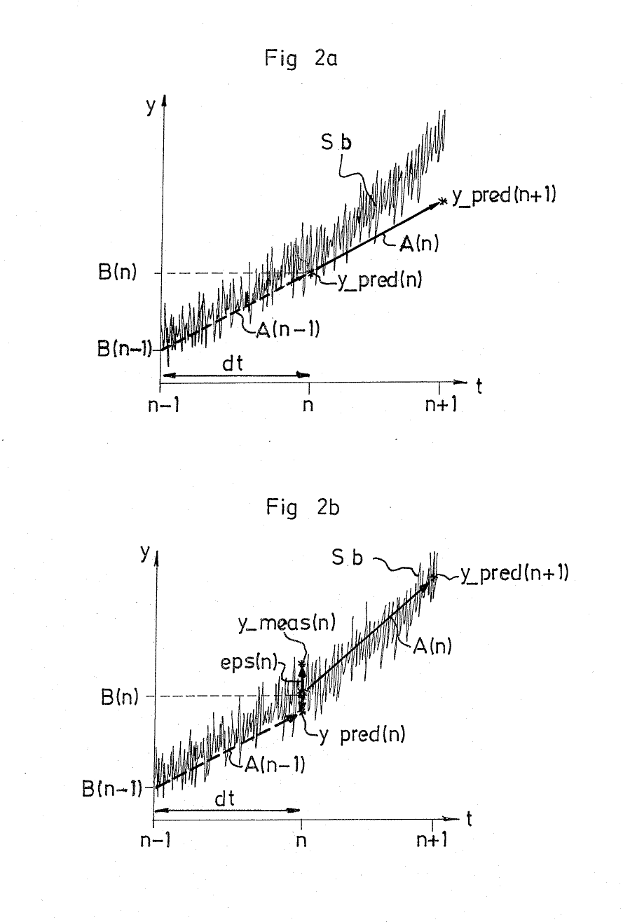

FIG. 2a is a schematic representation of the application of a Kalman filter to a signal, without correction,

FIG. 2b is a schematic representation of the application of a Kalman filter to a signal, with correction,

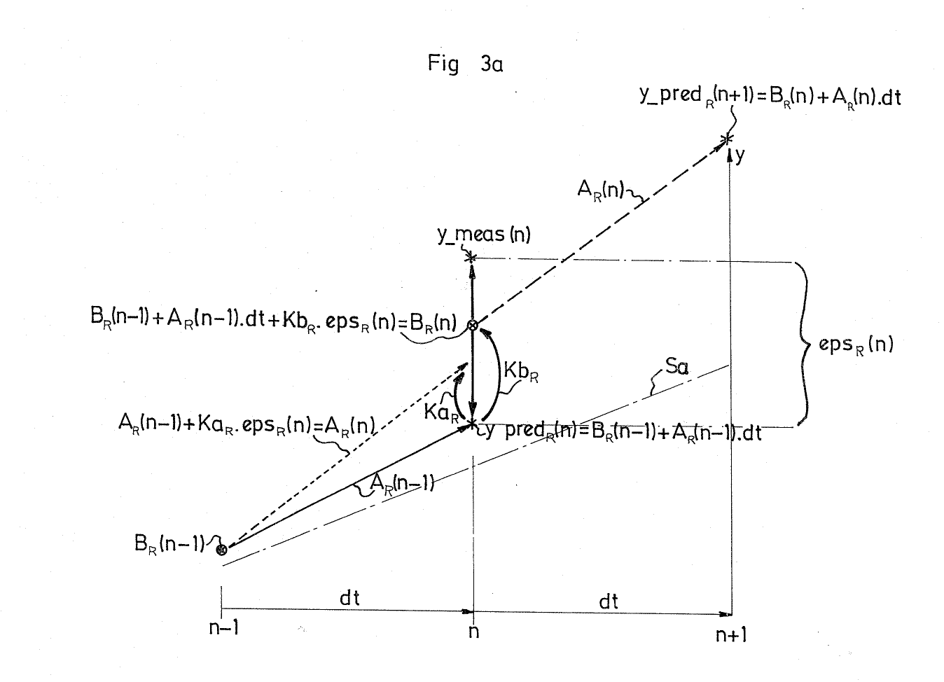

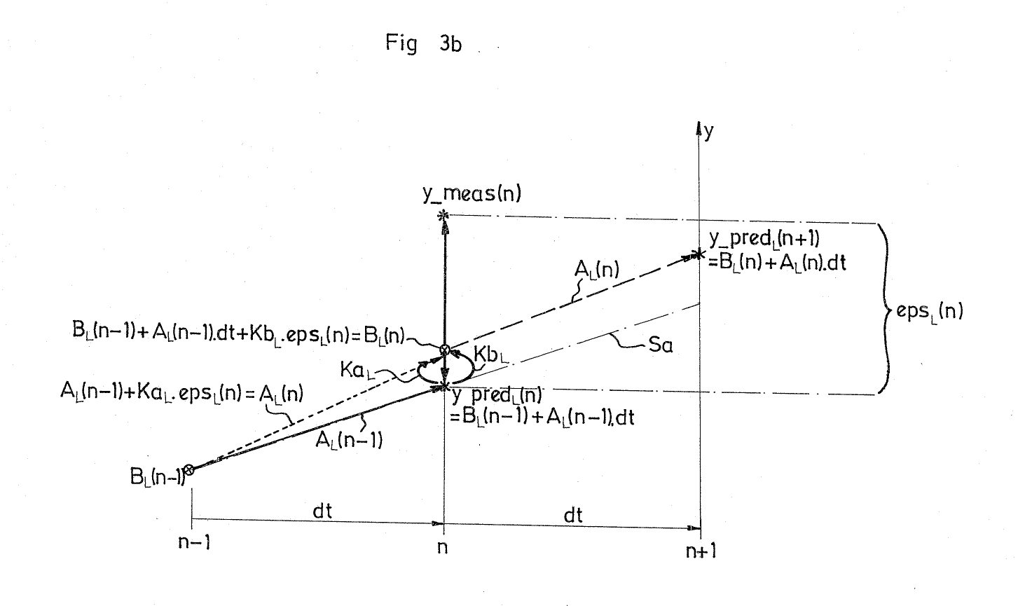

FIG. 3a is a schematic representation of the application of a rapid Kalman filter to a pressure signal, according to the invention,

FIG. 3b is a schematic representation of the application of a slow Kalman filter to a pressure signal, according to the invention,

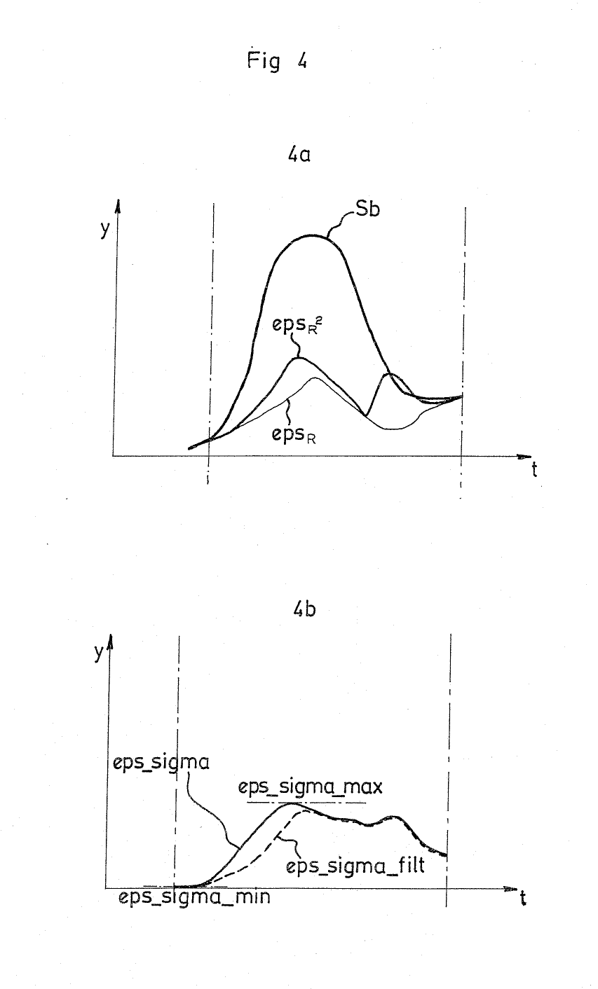

FIG. 4 is a schematic representation of the application of a Kalman filter to the detection of pressure spikes, according to the invention,

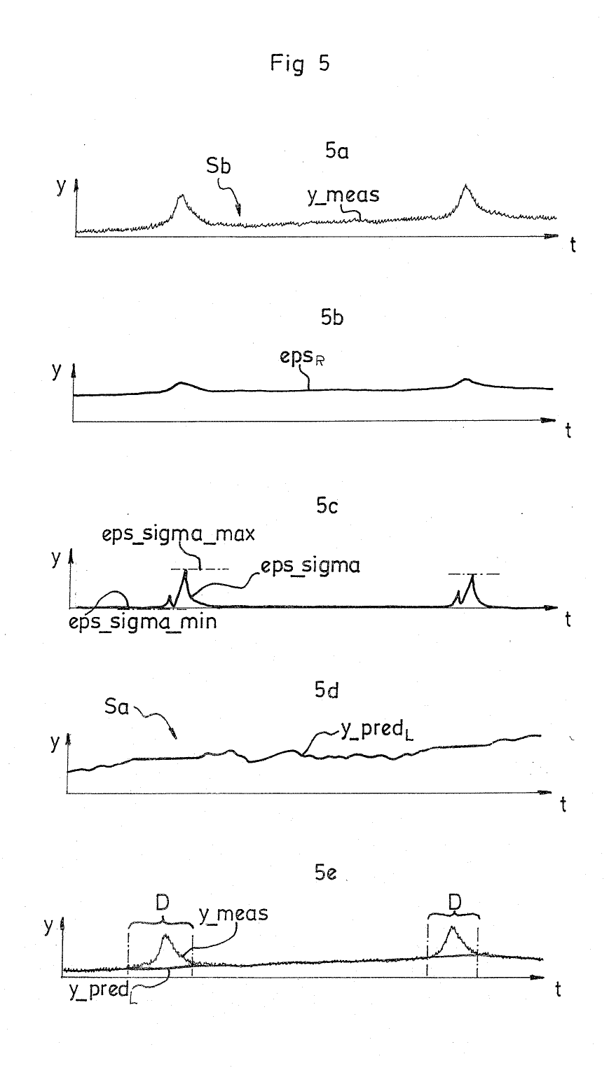

FIG. 5 is a schematic illustration of the processing of the pressure signal according to the invention.

A curve giving the variation of the real pressure Sr prevailing in the combustion chamber of a cylinder as a function of time is represented in FIG. 1a. This curve is comparable to a straight line centered on zero on which pressure spikes are overlaid. In the interests of simplification, a single pressure spike is represented in FIG. 1a.

FIG. 1b represents the noisy signal Sb as measured and supplied by the pressure sensor.

More specifically:
the basic signal Sa is no longer centered on zero, that is to say that the measured average pressure value is offset by a constant B,
the basic signal Sa is no longer parallel to the x axis, that is to say horizontal, but exhibits a slope which increases, of the type: y=A×x ,
the slope A and the constant B are not fixed in time and can therefore vary from one cycle to another.

Thus, the basic signal Sa can be likened to a straight line for which the equation is of the type y=A×x+B, on which signal pressure spikes are periodically overlaid.

The correction of the measured signal Sb is therefore necessary in order to obtain the signal which is representative of the real pressure Sr prevailing in the cylinder. For this, processing of the signal subtracts, from each point of the signal measured and supplied by the sensor Sb, the straight line y=A×x+B representing the drift of the signal, that is to say Sa, in order to retrieve the signal not affected by noise and without drift Sr.

FIGS. 2a and 2b illustrate the application of a Kalman filter to a signal of the type y=A×x+B, in which x represents the measurement instant t, in order to determine the slope A and the constant B. By applying this equation for each measurement instant n and by assuming that the slope A remains constant and that it is the same between the points n−1 and n, the following reference module is obtained (FIG. 2a):

A(n)=A(n−1)

The constant B at point n can then be calculated from the slope and from the constant at the point n−1, by considering the time interval dt between the points n−1 and n:

B(n)=B(n−1)+A(n−1)×dt

The prediction of the signal at the point n+1 is equivalent to:

y_pred(n+1)=B(n)+A(n)×dt (1)

y_pred(n+1) therefore represents the prediction of the signal at the point n+1 as a function of the parameters B and A determined at the point n.

The purpose of the Kalman filter is to compare, at the point n, this prediction with the measured real value y_meas(n) of the noise-affected signal Sb supplied by the sensor, and then to correct the slope, A(n), and the constant at the point n, B(n), so that the value of the predicted signal approaches the value of the signal Sb measured by the sensor.

Thus, the prediction error eps at the point n is therefore equivalent to:

eps(n)=y_meas(n)−y_pred(n) (2)

If this error is non-zero, the slope A(n) and the point n is not equal to the slope A(n−1) at the point n−1, (see FIG. 2b) and it must be corrected according to the prediction error of the slope eps(n) at the point n.

This correction is done using a gain Ka which represents the attenuation of the desired correction relative to the measured error.

A(n)=A(n−1)+Ka×eps(n) (3)

Similarly, a correction, equivalent to a portion of the measured prediction error, is applied to the constant B with a gain Kb, which gives:

B(n)=B(n−1)+A(n−1)×dt+Kb×eps(n) (4)

The values of the gains Ka and Kb are between 0 and 1. In the application of the Kalman filter, the adjustment of the gains Ka and Kb makes it possible to obtain a correction of the predicted value that is more or less dynamic relative to the value measured by the sensor. Thus, the higher Ka and Kb are, that is to say the closer to 1, the more dynamic the correction is and the more it approaches the measured value. On the other hand, the lower Ka and Kb are, that is to say the closer to 0, the slower the correction is and the more it remains distant from the measured value.

The duly corrected parameters A and B are used in the prediction formula (1) for the next point applied at n+1 (FIG. 2b).

The invention proposes using this method on the pressure signal in order to reliably determine therefrom the pressure spikes, the slope A and the constant B:
during a first step I, a first pair of high gains Ka_{R}, Kb_{R} is used for the application of a so-called “fast” filter, in order to obtain an estimation y_pred_{R}(n+1) close to the measured signal y_meas(n). Consequently, the increase in the slope, relative to the basic signal Sa, due to a spike, is detected rapidly via the rapid changing of the values of the slope A_{R} and of the constant B_{R} (FIG. 3a),
during the second step II, a second pair of gains, weaker than those used for the “fast” filter, Ka_{L}, Kb_{L}, is used for the application of a so-called “slow” filter, in order to obtain an estimation y_pred_{L}(n+1) that is closer to the basic signal to be extracted. In this case, a rapid increase in slope, illustrated by the point y_meas(n), is not taken into account for the prediction of the signal. The duly determined values of the slope A_{L} and of the constant B_{L} are the correct values of the slope and of the constant of the signal y=A×t+B of the basic signal Sa and they are not distorted by the presence of the pressure spikes (FIG. 3b),
finally, during the final step III, once the pressure spikes have been determined in the step I, and the values of the slope A and of the constant B have been determined during the step II, the straight line y=A_{L}×t+B_{L} is subtracted from the signal measured by the pressure sensor, in order to obtain the real signal of the pressure prevailing in the combustion chamber.

Obviously, the steps I and II run simultaneously and the correction made in the step III is then immediate.

The values of the gains Ka_{R}, Kb_{R}, Ka_{L} and Kb_{L} are between 0 and 1 and preferably the slope gains are less than the respective constant gains.

By applying the equations (1), (2), (3), (4) for each of the filters, the following equations are therefore obtained, for the fast filter:

eps_{R}(n)=y(n)−y_pred_{R}(n)

A_{R}(n)=A_{R}(n−1)+Ka_{R}×eps_{R}(n)

B_{R}(n)=B_{R}(n−1)+A_{R}(n−1)×dt+Kb_{R}×eps_{R}(n)

y_pred_{R}(n+1)=B_{R}(n)+A_{R}(n)×dt

and for the slow filter:

eps_{L}(n)=y(n)−y_{—} pred_{R}(n)

A_{L}(n)=A_{L}(n−1)+Ka_{L}×eps_{L}(n)

B_{L}(n)=B_{L}(n−1)+A_{L}(n−1)×dt+Kb_{L}×eps_{L}(n)

y_pred_{L}(n+1)=B_{L}(n)+A_{L}(n)×dt

It should be noted that the parameters A(n), B(n), eps(n) and y_pred(n) are specific to each of the filters, since the latter do not provide the same level of correction. As illustrated in FIGS. 3a and 3b, the corrected points obtained via these two filters, y_pred_{R}(n+1) and y_pred_{L}(n+1) are different.

According to the invention, and as illustrated in the graphs annotated 4a and 4b of FIG. 4, the fast Kalman filter is used for the detection of the pressure spikes. The prediction error eps_{R}(n) determined previously by the fast Kalman filter provides an indication concerning the stability level of the gradient of the signal and consequently concerning any rapid change of slope.

A pressure spike of the noise-affected signal Sb is represented by a pressure rise, a stabilization, then a fall. Consequently, for a pressure spike, the prediction error eps_{R} is a signal comprising two spikes, one positive representing the rise of the pressure spike, and a negative spike representing the fall (see FIG. 4a).

However, the presence of a background noise in, before or after the pressure spike also generates as spike (positive or negative) of the prediction error eps_{R} signal. Consequently, this signal is a succession of positive and negative spikes. Determining the duration of the pressure spike as a whole via this prediction error signal is therefore impossible.

During the step I, the invention proposes the following additional steps in order to nevertheless detect the pressure spike as a whole:
The square of the prediction error eps_{R} is used, this signal eps_{R}² consequently comprises two positive spikes to represent a pressure spike (see FIG. 4a). Determining the duration of the pressure spike as a whole is unfortunately not possible with this signal. In practice, this signal still passes through zero, making it impossible to use signal amplitude criteria in order to determine the duration of the pressure spike.
In order to obtain a signal that does not pass through zero, the square of the prediction error eps_{R}², or standard deviation, is filtered eps_sigma_filt: For this, a filtering coefficient Kys is applied. For example Kys=0.5.

eps_sigma_filt(n)=(1−Kys)×eps_sigma_filt(n−1)+Kys×eps_{R}(n)² (5)
This has the effect of slowing down the rise of the first spike of eps_{R}², of joining up with the 2^{nd} spike of eps_{R}² without passing through zero, then of slowing down the descent of the 2^{nd} spike of eps_{R}² (FIG. 4b). Consequently, the signal eps_sigma_filt that is obtained is a positive signal that does not pass through zero.

Then, in order to ensure that the start of a spike is detected rapidly, this filter is applied only once the spike has passed, which amounts to producing a signal consisting:
of the square of the prediction error eps_{R}² for the rise of the spike,
then of the filtered signal of the square of the prediction error eps_sigma_filt for the descent of the spike.

To produce this signal, the maximum of these two values over the duration of the spike is taken.

There is therefore obtained a maximized filtered signal eps_sigma equivalent to:

eps_sigma(n)=MAX└eps_sigma_filt(n), eps_{R}(n)²┘ (6)

The maximized filtered standard deviation eps_sigma is, over the duration of the pressure spike, a positive signal that does not return through zero (FIG. 4b), to which can be applied amplitude-related criteria in order to determine the start and the end of the pressure spike.

Thus, to detect the start of a pressure spike, at least one of the following two conditions is applied:
if it is found that the measured signal is greater than the predicted signal to which is added a constant: y_meas(n)>y_{—} pred_{R}(n)+delta1_up, that is to say, if the prediction error defined by the equation (2) is greater than a spike start threshold eps_{R}(n)>delta1_up,
and if the maximized filtered standard deviation eps_sigma, defined by the equation (6), is greater than a spike start standard deviation threshold eps_sigma_S1, eps_sigma(n)>eps_sigma_S1 , then the start of the pressure spike is detected, otherwise the pressure spike has not begun.

The spike start standard deviation threshold eps_sigma_S1 is chosen such that it has for its value the last minimum value of eps_sigma, that is to say, the value of eps_sigma at the start of the pressure spike eps_sigma_min (see FIG. 4b), multiplied by a spike start coefficient delta2_up.

That is to say: eps_sigma_S1=eps_sigma_min×delta2_up
with eps_sigma_min(n)=MIN[eps_sigma(n), eps_sigma_min(n−1)]

Similarly, for the detection of the end of a spike, at least one of the following two conditions is applied:
if the measured signal is smaller than the predicted signal to which is added a constant: y_meas(n) <y_{—} pred_{R}(n)₊delta1_down, which is equivalent to eps_{R}(n)<delta1_down, that is to say, if the prediction error, defined by the equation (2), is below a spike end threshold delta1_down,
and if the maximized filtered standard deviation eps_sigma, defined by the equation (6), is less than a spike end standard deviation threshold eps_sigma_S2, eps_sigma(n)<eps_sigma_S2, then the end of the pressure spike is detected, otherwise the pressure spike is not finished.

The spike end standard deviation threshold eps_sigma_S2 is chosen such that it has for its value the last maximum value of eps_sigma, that is to say, the value of eps_sigma at the top of the pressure spike eps_sigma_max (see FIG. 4b), multiplied by a spike end coefficient delta2_down.

That is to say eps_sigma_S2=eps_sigma_max×delta2_down with eps_sigma_max(n)=MAX[eps_sigma(n); eps_sigma_max(n−1)]

For any point n, it is therefore possible to determine whether or not it belongs to a pressure spike.

Generally, the spike start coefficient value delta2_up is between 0 and 10, the value of the spike end coefficient delta2_down is between 0 and 1, and the values of the spike start threshold delta1_up and spike end threshold delta1_down are between 0 and 5 volts.

Consequently, for each point n, if a spike is detected at this point, then the value of this point y_pred_{R}(n) cannot be selected for the estimation of the slope A and of the constant B, but, on the other hand, if a spike is not detected at this point, then the value of this point can be selected for the correct estimation of the slope A and of the constant B.

During the step II, the determination of the slope A and of the constant B according to the invention is performed via the slow Kalman filter. In practice:
the slope and the average constant are estimated via the Kalman filter with low gains Ka_{L} and Kb_{L}, in order to obtain a slow correction, less influenced by the changes of the signal, that is to say relatively independent of the pressure spikes, and therefore representative of the basic signal y=A×t+B,
the points n are then predicted by using the slope A_{L} and the constant B_{L} computed previously at the point n−1,

eps_{L}(n)=y(n)−y_pred_{L}(n)

A_{L}(n)=A_{L}(n−1)+Ka_{L}×eps_{L}(n)

B_{L}(n)=B_{L}(n−1)+A_{L}(n−1)×dt+Kb_{L}×eps_{L}(n)

y_pred_{L}(n+1)=B_{L}(n)+A_{L}(n)×dt
in the case where a spike has been detected previously at a point n via the fast

Kalman filter, the value of this point y_pred_{R}(n) is replaced by the value of the point predicted by the slow Kalman filter y_pred_{L}(n). The pressure spike is thus replaced by a signal of constant slope, that is to say by a straight line. This prediction is necessary in order for the determination of the slope A_{L} and of the constant B_{L} not to be distorted by the presence of the pressure spike.

In order to improve the accuracy of the values of the slope A_{L} and of the constant B_{L}, this step II may have variants. In practice, when the start of a spike is detected, the value of y_pred_{R}(n) can be replaced by the value predicted by the slow Kalman filter at the point n−2, that is to say y_pred_{L}(n−2). This is in order for the small start-of-spike increase not to overestimate the value of A_{L} and of B_{L}.

Similarly, in order to avoid underestimating the values of A_{L} and B_{L} at the end of the spike, the value of y_pred_{R}(n) is replaced by the value predicted by the slow

Kalman filter at the point n−1, that is to say y_pred_{L}(n−1).

During the last step III, the duly determined straight line y_pred_{L}(n+1)=A_{L}(n)×t+B_{L}(n), representing the basic signal Sa, is subtracted from the signal provided by the sensor in order to reconstruct the true curve of pressure prevailing in the combustion chamber, that is to say comprising a rectilinear basic signal recentered on zero.

The various steps in processing the signal according to the invention are illustrated in FIG. 5, comprising 5 graphs annotated 5a, 5b, 5c, 5d and 5e.

FIG. 5a represents the signal measured by the sensor, comprising two pressure spikes and a drift of the basic signal of the type: y=A×t+B.

FIGS. 5b and 5c illustrate the processing of the signal during the step I:
FIG. 5b represents the prediction error eps_{R} of the measured signal,
FIG. 5c represents the standard deviation of the maximized filtered prediction error eps_sigma, and also the values eps_sigma_min and eps_sigma_max.

The step II is illustrated in FIG. 5d. The basic signal y_pred_{L} obtained by the slow Kalman filter is represented, in which the pressure spikes obtained by the fast Kalman filter are replaced by straight lines.

FIG. 5e represents the detection region D of the two spikes, and also the basic signal y_pred_{L} duly determined by the performance of the step III.

The invention therefore makes it possible to determine the slope A, the constant B and the pressure spikes reliably, without requiring significant memory size since the method is recursive of order 1 and predictive, from a point n to a point n+1, and does not require management and storage over a long window of a number of points to apply the conventional least squares formulae. This method can, consequently, be incorporated in a cylinder pressure sensor or in an engine computer.

Obviously, the invention is not limited to the embodiment described and represented, which has been given solely as an example and may, for example, be applied to any measurement signal which includes spikes.

### LIST OF THE REFERENCES USED

Sa: Basic signal

Sb: Signal supplied by the sensor

Sr: Real signal

1. A method for correcting the drift of the signal (Sb) from a pressure sensor measuring the pressure in a cylinder of an internal combustion engine, the signal being comparable to a succession of points forming a basic signal (Sa) represented by a straight line of equation y=A×x+B, of slope A and of constant B, on which signal are overlaid pressure spikes, said correction method comprising the following steps:
I: the use of a rapid Kalman filter, that is to say, comprising gains of slope (Ka_{R}) and of constant (Kb_{R}) with values close to 1, for the detection of the points belonging to the pressure spikes,
II: the use of a slow Kalman filter, that is to say, comprising gains of slope (Ka_{L}) and of constant (Kb_{L}) with values close to 0, for the determination of the slope (A) and of the constant (B) of the straight line representing the basic signal,
III: the correction, for each point, of the drift of the signal according to whether or not they belong to the detected pressure spikes determined during the step I and of the values of the slope (A) and of the constant (B) determined during the step II in order to determine the real signal (Sr) of the pressure prevailing in the cylinder,
characterized in that, during the step I:
the prediction error (eps_{R}) on a point of the signal is estimated using the rapid Kalman filter used,
the standard deviation of this prediction error (eps sigma) is filtered and maximized to estimate the stability of this point relative to the preceding points,
the start and/or the end of a pressure spike at this point is determined according to at least one of the following two criteria:
the prediction error (eps_{R}) on this point is above a spike start threshold (delta1_up),
the filtered and maximized standard deviation of the prediction error (eps_sigma) on this point is above a spike start standard deviation threshold (eps_sigma_S1).

2. The method as claimed in claim 1, characterized in that the spike start standard deviation threshold (eps_sigma_S1) is equivalent to the last minimum value of the filtered and maximized standard deviation (eps_sigma_min), multiplied by a spike start coefficient (delta2_up).

3. The method as claimed in claim 2, characterized in that the spike start coefficient value (delta2_up) is between 0 and 10.

4. The method as claimed in claim 1, characterized in that, during the step I, the end of the spike is determined at a point according to at least one of the following two criteria:
the prediction error (eps_{R}) on this point is below a spike end threshold (delta1_down),
the filtered and maximized standard deviation of the error (eps_sigma) on this point is below a spike end standard deviation threshold (eps_sigma_S2).

5. The method as claimed in claim 4, characterized in that the spike end standard deviation threshold (eps_sigma_S2) is equivalent to the last maximum value of the filtered and maximized standard deviation (eps_sigma_max), multiplied by a spike end coefficient (delta2_down).

6. The method as claimed in claim 1, characterized in that, during the step II:
the slope (A) and the constant (B) of the straight line are estimated from the slow Kalman filter,
the points belonging to the pressure spike determined by the rapid Kalman filter during the step I are replaced by the points predicted by the slow Kalman filter by using the previously estimated slope (A_{L}) and constant (B_{L}).

7. The method as claimed in claim 1, characterized in that, during the step III, the predicted straight line y=A_{L}×t+B_{L}, determined during the step II, is subtracted from the signal obtained from the sensor.

8. The method as claimed in claim 1, characterized in that the slope gain of the rapid Kalman filter (Ka_{R}) is greater than the slope gain of the slow Kalman filter (Ka_{L}).

9. The method as claimed in claim 1, characterized in that the constant gain of the rapid Kalman filter (Kb_{R}) is greater than the constant gain of the slow Kalman filter (Kb_{L}).

10. The method as claimed in claim 1, characterized in that the slope gain of the rapid Kalman filter (Ka_{R}) is less than the constant gain of the rapid Kalman filter (Kb_{R}).

11. The method as claimed in claim 1, characterized in that the slope gain of the slow Kalman filter (Ka_{L}) is less than the constant gain of the slow Kalman filter (Kb_{L}).

12. A device for correcting a signal implementing the method as claimed in claim 1.

13. The device as claimed in claim 12, characterized in that the signal is a pressure signal from a cylinder of an internal combustion engine.

14. A pressure signal sensor comprising the device for correcting a pressure signal as claimed in claim 12.

15. An electronic computer comprising the device for correcting a pressure signal as claimed in claim 12.
